(19) United States
(12) Patent Application Publication
(10) Pub. No.: US 2015/0316908 A1
(43) Pub. Date: Nov. 5, 2015

(54) SENSOR SYSTEM

(71) Applicants: Theodore Eller, Pompano Beach, FL (US); Charles Hart, Davie, FL (US); William Pfarr, Pompano Beach, FL (US); Jimmie H. Spraker, Palm BAy, FL (US)

(72) Inventors: Theodore Eller, Pompano Beach, FL (US); Charles Hart, Davie, FL (US); William Pfarr, Pompano Beach, FL (US); Jimmie H. Spraker, Palm BAy, FL (US)

(73) Assignee: Mount Everest Technologies, LLC, Pompano Beach, FL (US)

(21) Appl. No.: 13/884,530

(22) PCT Filed: Nov. 14, 2011
(86) PCT No.: PCT/US2011/060570

§ 371 Date: Sep. 17, 2013

Related U.S. Application Data
(60) Provisional application No. 61/412,926, filed on Nov. 12, 2010.

(51) Int. Cl. G05B 15/02; H04W 4/00

(52) U.S. Cl. CPC G05B 15/02; H04W 4/008

(57) ABSTRACT

A sensor system includes a sensor module disposed in a compartment. The sensor module includes first and second sensors, a first processor, and a first transceiver. The second sensor is separated from the first sensor in the compartment. The first processor is configured to monitor the first and second sensors. The first transceiver is configured to transmit sensor data from the first processor to a location remote from said compartment.

### CROSS-REFERENCE TO RELATED APPLICATIONS

This application claims priority to U.S. Patent Application Ser. No. 61/412,926, which was filed on Nov. 12, 2010, the entirety of which is herein incorporated by reference.

### BACKGROUND OF THE INVENTION

The present invention addresses a need by providing a system and method for automating and analyzing electric systems or similar devices non mechanically.

### SUMMARY

In some embodiments, a sensor system includes a sensor module disposed in a compartment. The sensor module includes first and second sensors, a first processor, and a first transceiver. The second sensor is separated from the first sensor in the compartment. The first processor is configured to monitor the first and second sensors. The first transceiver is configured to transmit sensor data from the first processor to a location remote from said compartment.

### BRIEF DESCRIPTION OF THE DRAWINGS

FIG. 1 is a block diagram of one example of an improved sensor system;

FIG. 2 is a simplified block diagram of one example of a sensor module that can be used with the sensor system illustrated in FIG. 1;

FIGS. 3A-3C illustrate a flow diagram for one example of a calibration algorithm that may be performed using the improved sensor system illustrated in FIG. 1.

FIG. 4 is a flow diagram of a typical client-server system.

### DETAILED DESCRIPTION

This description of the exemplary embodiments is intended to be read in connection with the accompanying drawings, which are to be considered part of the entire written description. Like reference numbers refer to like parts throughout the specification.

A Control Sensor System (“CSS) is disclosed that includes a printed circuit board (“PCB”) configured to manage real-time control of devices and is configured to function as a stand-alone system. In one particular embodiment, the CSS is configured to transmit status information (in the form of “events”) and status control signals to a main computer for processing. The communication of the events may be via radio frequency (“RF”) signals and/or by AC/DC power line modulated communication systems. In such an embodiment, if an action has exceeded a preset parameter or threshold, an “event” message is sent to a main computer for processing and for indicating the status of the device. The main computer can be connected to the internet and/or to a wired or wireless provider so that the event can be reported to a user and/or so that that the user can control and/or monitor the status of the Sensor Module (“SM”). In some embodiments, a user can use a remote device to control and/or switch on, off, or control of each SM connected device.

The improved systems and methods disclosed herein include sensors and methods for controlling and detecting a status of a monitored system to provide continuous monitoring and control of the system. In some embodiments, a user interacts with the system using a Graphical User Interface (“GUI”) that provides status and override control to and from a computer located in a control room or another remote location or area.

In some embodiments, sensor system is configured to monitor fluids and to control up to and including 256 different devices simultaneously; however, one skilled in the art will understand that the improved sensor systems may monitor fewer or more different devices simultaneously. Additionally or alternately, the improved systems may be used to monitor levels and control functions for any type of liquid, solids, air flow, pressure, electrical currents, and heat. The improved sensor systems may also be configured to actuate any desired event on the basis of the equipment being monitored.

The present application incorporates herein by reference, in its entirety, U.S. patent application Ser. No. 12/713,707, filed on Feb. 26, 2010, which published as U.S. Patent Application Publication No. 2010/0215511 A1 on Aug. 26, 2010, and which is and entitled Level Sensor System. Certain additions, improvements and/or modifications to that system will be described herein.

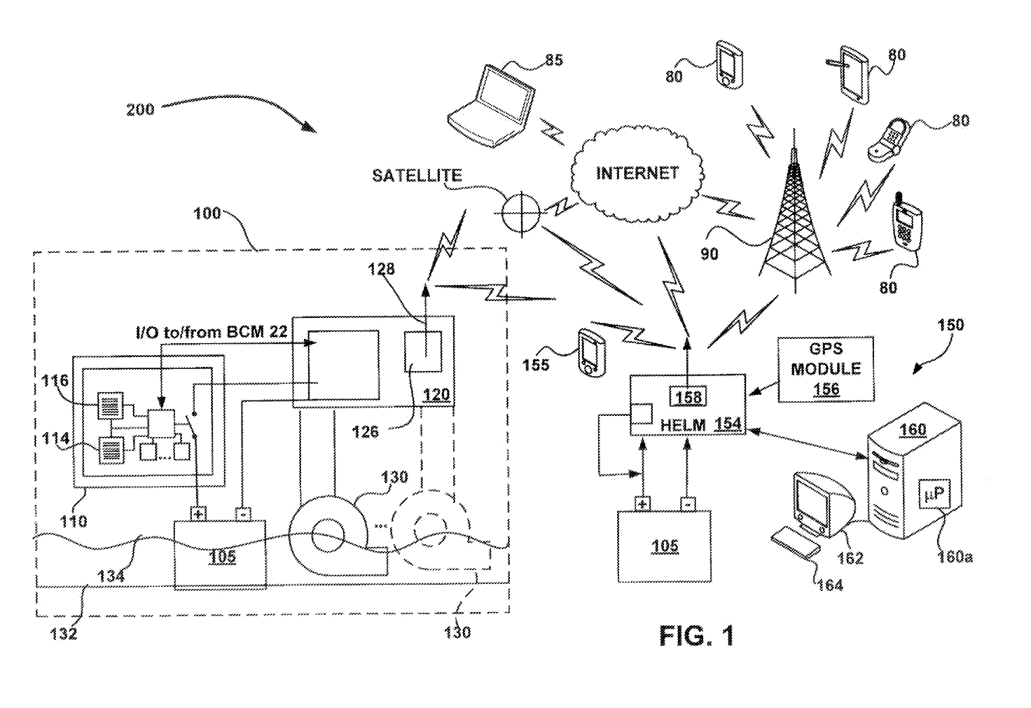

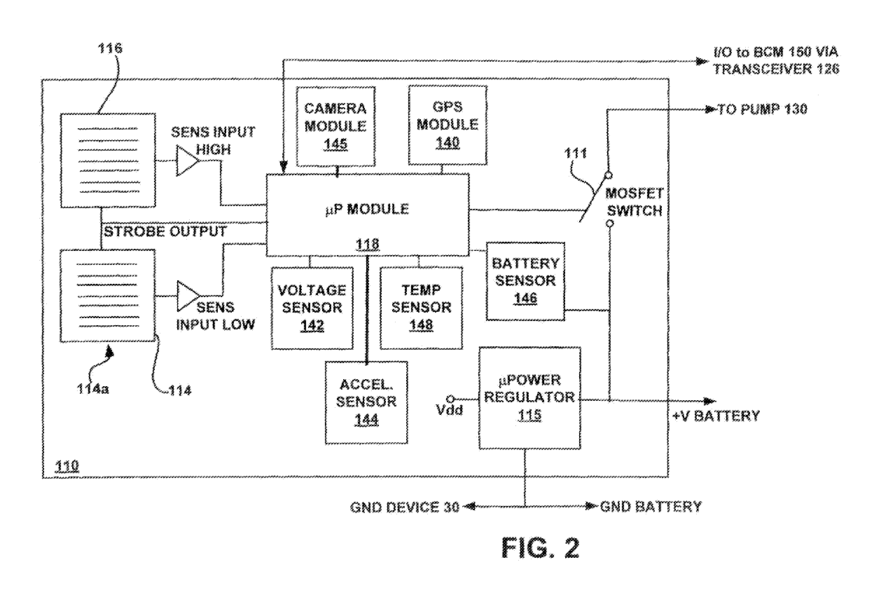

Referring now to FIGS. 1-2, a system 200 is provided for detecting substances level 134 above the set point 132 of a compartment, chamber, reservoir, hose, passage, or any other apparatus that may be monitored. System 200 can also be used to determine when to activate and/or deactivate a function to evacuate a substance from the compartment or chamber 100 based on information received by a sensor module (“SM”) 110. SM 110 includes the sensors and the sensing electronics for the system 200. Exemplary sensors include, but are not limited to, capacitive sensors. Additionally, the SM 110 includes a microprocessor module 118 that processes information from the sensors 114 and 116 in order to make a determination about whether a substance is in the chamber 100 and when to actuate (i.e., turn on, off, or regulate) a device 130, which may be an electrical device, such as a pump, a chiller, a heater, an alarm, a valve or any other device. The SM 110 is embodied as a printed circuit board (PCB).

As shown more particularly in FIG. 2, SM 110 includes at least two sensors 114, 116 formed on a PCB. The number of sensors used with SM 110 may range from one sensor up to, including, and beyond 256 sensors. In some embodiments, sensor 114 is a low-level sensor and sensor 116 is a high-level sensor. Low sensor 114 and high sensor 116 are positioned vertically above a floor 132 (FIG. 1) of the compartment 100 with the high sensor 116 being disposed vertically above the low sensor 114. In embodiments in which more than two sensors are used, a further high sensor may be disposed above high-sensor 116 such that high-sensor 116 is configured to sense a first level that is above the level of sensor 114 and the further high sensor is configured to sense a level that is above the first level sensed by sensor 116. In one particular embodiment, sensor 116 is disposed 2.5 inches above the sensor 114 on the SM 110.

Microprocessor 118 is configured to monitor a level of the substance in chamber 100 relative to the lower edge 114a of the low sensor 114. In some embodiments, the lower edge 114a of low sensor 14 is preferably about 0.75 inches above floor 132 of compartment 100. In some embodiments, the lower edge 116a of high sensor 116 is about 4.25 inches above floor 132 of compartment 100. In an embodiment using a further high-sensor (not shown) is implemented, the lower edge of the further high-sensor is about 7.25 inches above floor 132 of compartment 100. As will be understood by one skilled in the art, the sensors of SM 110 can be disposed in a variety of vertical and horizontal positions relative to one another.

In some embodiments, the low and high sensors 114, 116 are configured to sense a capacitive change in a sensor that senses a ratio of matter to air. For example, the ratio of the capacitance of water to the capacitance of air is approximately 125:1. For example, the ratio can be 125:1+10%, 125:1+5%, or +2.5%. System 200 monitors the capacitive ratio of water to air and detected by sensors 114, 116. SM 110 is located in chamber 100 such that the sensors 114, 116 are exposed in order to be contacted by any matter or substance in chamber or compartment 100 that rises to the level of sensors 114, 116. In one embodiment, for example, the depth of penetration of the sensing field of the sensors 114, 116 is approximately ¾″ (0.75 inches) up to 2¾″ (2.75 inches). Other calibrations and sensing fields of sensors can be used and may change based on the substance being measured/controlled.

Sensing is achieved by monitoring the sensors 114, 116 to determine a change in frequency from a preset baseline or threshold value by on-board microprocessor 118, which then watches for a change in frequency to be received from the sensors 114, 116. The absence of a response from either of the sensors 114, 116 may be determined by the firmware calibration and measurement algorithms. A reduced frequency response from sensors 114, 116 may indicate that only air is present at sensors 114, 116. An increase frequency response may indicate level or slosh conditions. A full response received by the microprocessor 118 from either of the sensors 114, 116 indicates complete or if desired partial immersion or contact of the responding sensor. The microprocessor 118 can intelligently discriminate these conditions and make a decision on whether or not to actuate the system 130, by opening or closing the switch 111. Switch 111 may be a 100 amp MOSFET switch that is electronically controlled by microprocessor 118.

In some embodiments, the system/device 130 is turned on by the microprocessor 118 by closing the switch 111 if it is determined that the level in the compartment 100 has exceeded the lower edge of the high sensor 116. In the embodiment illustrated in FIG. 1, system 130 remains under the control of the microprocessor 118 until it has been determined that the reading in the compartment 100 has fallen to below the level of the low sensor 114. Once the level of the substance in compartment 100 is below the lower edge 114a of sensor 114, microprocessor 118 opens switch 111 to deactivate the system/device 130. System/device 130 may not be reactivated until microprocessor 118 determines that the substance in compartment 100 rises above a threshold level, which may be the saturation of sensor 116. Actuating system/device 130 once sensor 116 is submerged provides hysteresis and slosh immunity as will be understood by one skilled in the art.

System 130 may also be remotely activated a computer 160 and/or by a user command received in the microprocessor 118. For example, when the level 134 is present above preset base 132, SM microprocessor 118 initiates a transmission of information from transceiver 126 to transceiver 158 of command module (“CM”) 150. In response to this information, CM 150 may actuate the systems or other system/device 130 through SM microprocessor 118. Additionally, if desired, a plurality of systems or other devices 130 (shown in dotted line in FIG. 1) can be included in compartment 100 and controlled by microprocessor 118 and/or the microprocessor 160a of the CM 150.

The SM 110 additionally includes other types of sensors and modules for monitoring other conditions relating to the SM 110 and/or the compartment 100. For example, the SM 110 of FIG. 2 is shown as including a GPS module 140, a battery level sensor 142, a voltage sensor 146, and a temperature sensor 148. Additionally, the SM 110 can include an on-board acceleration sensor or accelerometer 144 that is additionally monitored and/or controlled by the microprocessor 118. Information from accelerometer 144 may be used, for example, to determine the mounted location of the SM 110 system. Many other uses can additionally be made of the accelerometer 144.

Additionally, a camera module 145 can be included in the SM 110 in order to capture video images of the surrounding area. Camera module 145 can provide an output to microprocessor 118 so that the information from the camera module 145 is included in the data string sent by microprocessor 118 to the computer 160 for processing and image construction. The processed image data from the camera module 145 can then be transmitted to a user device 80 or to the internet for display on a website. Information received from the OPS module 140 and sensors 142, 144, 145, 146, and 148 (FIG. 2) is received and processed by the microprocessor 118.

GPS module 140 and sensors 142, 144, 145, 146, and 148 can be included on the PCB forming the SM 110. A special calibration algorithm can be used in the SM 110 to detect and compensate for the components, sensor pattern, sensor layout, sensor size, sensor distance from enclosure, and the enclosures thickness. That calibration algorithm is reproduced in Table 1, here below.

TABLE 1
calibrate:

| serout2 PortC.xx, xx [“Cal>”] | |
|---|---|
| IF (pc_command − “xxxxx”) Then raw_data_only | |
| base1 = xxxxx | |
| base2 = xxxxx | |
| for y = 1 to xx | |
| count PortC.xx, 1500, base1 xxxxx1 | ‘count low sensor as a baseline for later |
| | comparison |
| count PortC.xx, 1000, basehxxxxx1 | ‘count high sensor as a baseline for later |
| | comparison |
| base1 = base1xx + base11xxx | |
| base2 = base2xx + baseh1xxx | |
| next y | |
| base1xx = base1 / xx | ‘average out the xx readings |
| base2xx = base2 / xx | |
| Write 10, base1.HIGHBYTE | ‘write high byte of word and store Low level |
| | sensor base value in EEPROM location xxx |
| write 10 + 1, base1.LOWBYTE | ‘write low byte of word to next address |
| pause 15 | |
| Write 20, base2.HIGHBYTE | ‘write high byte of word of High Sensor |
| write 20 + 1, base2.LOWBYTE | ‘write low byte of word to next address and |
| | store High base value in EEPROM location |
| pause 15 | xxx |

goto exit_calibrate

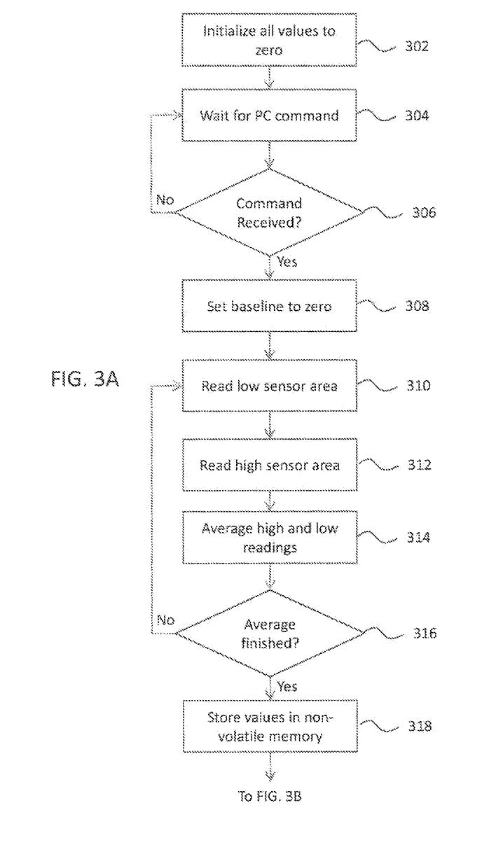

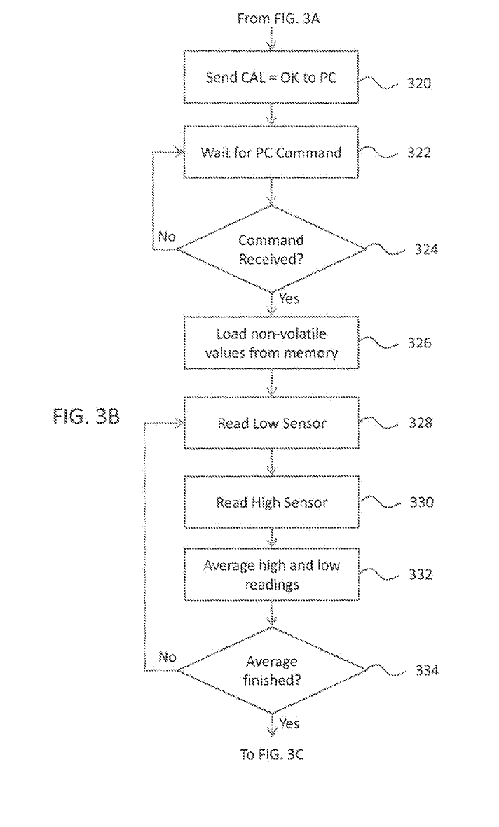

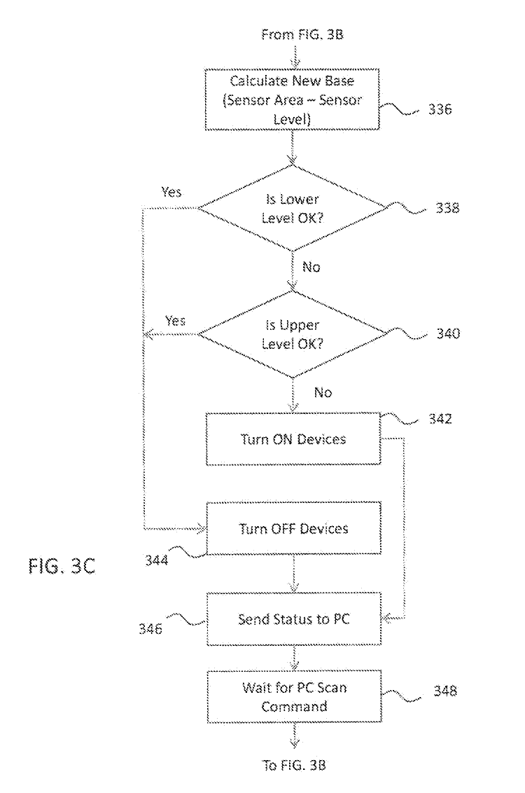

The calibration algorithm may also set the base capacitance detection to be the most sensitive on the enclosure surface close to the given sensor (high or low) position. A flow diagram showing the operation of the calibration algorithm 300 is provided in FIGS. 3A-3C.

As shown in FIG. 3A, all values are initialized to zero at block 302. At block 304, sensors 114, 116 wait for a command from microprocessor 118. Algorithm 300 moves to decision block 306 and determines if the command is received. If the command is not received, algorithm 300 moves back to block 304 and waits for the command. If the command is received, algorithm 300 moves to block 308 and sets a baseline or threshold value to zero.

At block 310, the low sensor 114 is polled to determine a sensed value of the low sensor 114. At block 312, the high sensor 116 is polled or queried to determine a sensed value of the high sensor 116. The values received from sensors 114, 116 are averaged together at block 314.

At block 316, a check is made to determine if all of the sensor values have been averaged together. If the average is not complete, the steps embodied in 310-14 are repeated. If the average is complete, at 318 the values are stored in non-volatile memory and the process continues to FIG. 3B.

Referring now to FIG. 3B, at block 320 a message is sent to the PC to indicate that the calibration is OK. At block 322 the system enters a wait state to wait for a command from the PC. At 324, a check is made to determine if a command has been received. If no command is received, the method returns to block 322 to wait for a command. If a command has been received, at 326 the values stored in memory at block 318 are retrieved. The process then reads the low sensor at 328, the high sensor at 330, and averages the readings at 332. If the check at 334 determines that the average calculations are complete, the process continues to FIG. 3C. Otherwise, steps 328-32 are repeated.

Turning to FIG. 3C, at 336 a new base is calculated from the sensor area and the sensor level. Next, the lower level is checked at 338 and the upper level is checked at 340. If either conditional returns a positive result, meaning the upper level or the lower level are “OK,” e.g., a desired condition is met, the process continues to 344 where the devices are turned off. If neither the lower level nor the upper level are “OK,” the method continues to 342 where the devices are turned on. After the devices have either been turned on or turned off, the device status is sent to the PC at 346. At 348, the process again enters a wait state and returns to FIG. 3B.

Referring back to FIGS. 1 and 2, the SM 110, and the components thereon, can be powered by any number of power sources. For example, SM 110 can be powered by the battery bus of the vehicle in which it is used. Additionally, in one particular embodiment, the customer power supply is used to power the main computer 160. It takes its source from the mains and regulates and filters the voltage to 12.0 VDC at 3 amps. The input range, in this particular embodiment, the input range is from 12 VDC to 36 VDC, and can be increased with a change of one on-board device to extend the range from between 12 VDC to 75 VDC.

As can be seen more particularly from FIG. 2, a DC power regulator 115 can be formed as part of the PCB containing the SM 110. Such a power regulator 115 is capable of receiving a 6V-80V DC input and is immune to power bus transients including starter noise. In such a system, the SM 110 would draw less than 1 milliamp making it ideal for long term battery operations. In one embodiment, the SM 110 and systems/devices 130 are powered by 12 to 36 VDC batteries.

Referring against to FIG. 1, the SM 110 is configured to communicate status and control information to a remote location. For example, the SM 110 can communicate status and control information a transceiver 126 located proximal to the SM 110 (i.e., within the same compartment 100). Transceiver 126 enables SM 110 to communicate, bidirectionally, with CM 150. Microprocessor 118 communicates with the CM 150 by wireless communication, such as by using RF signals. Accordingly, transceivers 126 and 158 may be configured for wireless communication. Note however, the RF transceivers 126, 158 could be replaced by a wired connection between the SM 110 and the CM 150. Similarly, the transceivers 126, 158 could communicate using wireless systems, including, but not limited to, UHF band, WIFI, and BLUETOOTH, to name only a few non-limiting examples.

As shown more particularly in FIG. 1, the CM 150 includes a main computer 160 including a CM microprocessor or CPU 160a that is arranged to monitor and control the functions of the system 200. A display or monitor 162 and keyboard or other user input device 164 can be provided to permit user communication with the microprocessor 160a. Additionally, the microprocessor 160a can be programmed by firmware and/or software stored in a memory associated with the computer 160 and executed to perform defined functions in the same manner as is done in conventional computers/microprocessors.

The CM microprocessor 160a communicates with the SM microprocessor 118, using a communications module or wireless modem 154 that includes a transceiver 158. More particularly, the transceiver 158 communicates information to and from the transceiver 126 of the SM 110. Each of the transceivers 126 and 158 are powered by a regulated 5V DC power source. In one embodiment of the invention, the transceivers 128 and 158 communicate wirelessly, using RF antennas. In some embodiments, transceivers 128 and 158 are XBEE® or XBEE-PRO® RF transceivers, produced by Digi International Inc. Such XBEE® or XBEE-PRO® RF transceivers exhibit the following performance characteristics:
Power Output:
   63 mW (+−18 dBm) North American version;
   10 mW (+10 dBm) International version;
Indoor/Urban range of up to 300 ft (90 m);
Outdoor/RF line-of-sight range of up to 1 mile (1.6 km) RF LOS;
RF data rate of 250 Kbps;
Interface data rate of up to 115.2 Kbps;
Operating frequency of 2.4 GHz;
Receiver sensitivity of −100 dBm.

The XBEE® or XBEE-PRO® RF transceiver additionally exhibit the following networking characteristics:
Spread Spectrum technology utilizes direct sequence spread spectrum (DSSS) technology;
Networking topology permits point-to-point, point-to-multipoint and peer-to-peer networking;
Error handling permits retries and acknowledgements;
Filtration options include PAN ID, Channel and 64-bit addresses;
Channel capacity is:
   XBEE®: 16 channels;
   XBEE-PRO®: 12 channels;
65,000 network addresses are available for each channel.

The communications system 154 is configured like a typical COM port used on a personal computer and, thus configured, permits a wireless, bidirectional link to be made with the SM 110 within a theoretical 1 mile radius. However, one skilled in the art will understand that other communication protocols may be used to expand the radius of the bidirectional link. Within this link, the CM 150 becomes the master controller and the SM 110 becomes the slave device. Note that, it is understood that a plurality of SMs 110 can be controlled by a single CM 150 using only one RF channel, if desired. The advantages provided by the use of the communications system 154 and transceiver 126, and more particularly, in integrating them into a system including the main computer 160 and/or the internet, includes, among other things:
The control of all logic is performed in a processing program running on a computer, such as the main computer 160 or remote computer 85. An MET program listens for commands from the remote computer 85 (or from the internet).
Bidirectional wireless communications between the CM 150 and the SM 110 can occur, theoretically up to a one mile range.
Sensor events from the SM sensors 142, 146, 148, and GPS module 140 are transmitted from the SM 10 to the computer 160. The SM 110 has several sensors that are monitored and processed. These sensors permit monitoring of such things as substance level, via the capacitance sensors 114, 116, battery level, temperature, voltages present at the pump(s) 130 and the GPS data stream, among others.
The CM computer 160 is configured to send commands to the SM for a full bidirectional system.
All data is present and available for processing, control and commands via the internet, as well as, via special server software that resides on the World Wide Web and the host computer (computer 85 and/or computer 160).
The use of the XBEE® or XBEE-PRO® transceivers, in particular, provides for a very simple communications protocol, wherein 2 byte commands from the CM 150 are sent to the SM 110 and one multi-length data sensor reading can be sent from the SM to the computer 160 and/or 85.
Confirmation for each received command is provided by the SM 110 and the computer 160 of the CM 150. In one embodiment, for every command sent, the response is given by “OK->”. If this data set is not received, then the software running on the respective microprocessor 118, 160a will report an error, a loss of signal, or an event that did not occur, etc.
Each SM 110 and the controlling computer 160 are given their own ID's. The system presently has a capability of >65,000 IDs, which number can be expanded as needed.

The system 200 can additionally include a handheld controller 155 that can be used as a service tool. The handheld controller 155 can contain a compatible RF transceiver to permit bidirectional communications with the RF transceivers 126, 158. In one particular example, the RF transceiver of the handheld controller 155 is an XBEE® or XBEE-PRO® transceiver module, as previously described herein. However, the handheld controller 155 may contain a different microcontroller that sends commands at a touch of a button on the handheld controller 155, in order to stop, start, or control a given device, such as the pump(s) 130. This allows the user to have full control while servicing the device, even when away from the CM computer 160.

CM 150 can be programmed to command, control, or regulate the SM 110 to activate, deactivate, or regulate one or more devices 130 thus overriding the SM 110 in the event of a failure of the SM 110, or in accordance with a demand from a user. The CM 150 can also be used to retrieve and log statuses, including level, activation, and temperature history of the SM 110 using information received from the GPS module 140 and/or sensors 114, 116, 142, 144, 145, 146 and 148. Alternatively or additionally, CM 150 can include a GPS module 156 and the GPS module 140 can be omitted.

CM 150 may be mounted in a bridge area of a boat or ship, control room, vehicle dash, building, office, or vehicle. The CM 150 monitors one or more substances, temperature, and battery status of each SM 110 and saves a historical event record. More particularly, each of the GPS modules 140 and/or sensors 114, 116, 140, 142, 144, 145, 146 and 148 of each SM 110 provides information to the microprocessor 118 of that SM 110. In one embodiment, the CM 150 operates as a master controller while the one or more SM 120 unit(s) act(s) as slave modules. The CM 150 polls each of the SMs 120 (up to 32 SMs 120, in this embodiment) once per minute and waits for a response from each of the addressed SMs 120 until proceeding or defaulting to the next SM 120 after time-out.

As will be understood by one skilled in the art, GPS module 140, 156 includes a microcontroller (not shown). The microcontroller of the GPS module 140 or 156 can be programmed with software or firmware to provide for the continuous monitoring of multiple, e.g., 3 to 12, satellites and calculate the latitude, longitude, altitude, speed and heading that is passed to the control software once per second for display, which information can be sent via emails or voice and messaging alerts to a user. The GPS microcontroller would be configured to communicate bidirectionally with the main software, so as to receive commands from the main software and to respond with a corresponding data request.

If provided as part of the system 100, a GPS module 140, 156 can be used to provide standard, raw NMEA0183 (National Marine Electronics Association) strings or specific user-requested data via the serial command interface, tracking of a number, e.g., 12, satellites. GPS module 140, 156 may also be configured to provide WAAS/EGNOS (Wide Area Augmentation System/European Geostationary Navigation Overlay Service) functionality for more accurate positioning results. Additionally, GPS module 140, 156 can be used to provide the current time, date, latitude, longitude, altitude, speed, and travel direction/heading, among other data, and can be used in a wide variety of commercial applications, including navigation, tracking systems, mapping, fleet management, and auto-pilot. For example, the GPS module 140 of the SM 110 receives information from the Global Positioning Satellite System, including Global Positioning System Fix Data, which includes time, position and fix related data for a GPS receiver.

In one embodiment, the Global Positioning System Fix Data received by the GPS module 140 or 156 from the GPS satellite system, additionally includes:
The coordinated universal time (“UTC”) at the position;
The latitude of the position;
Information indicating the north or south latitude hemisphere;
Information indicating the east or west longitude hemisphere;
A GPS quality indicator (0=no fix, 1=non-differential GPS fix, 2=differential GPS fix, 6=estimated fix);
The number of satellites in use;
The horizontal dilution of precision;
Antenna altitude above mean-sea-level, in meters;
The geoidal height, in meters;
The age of the differential GPS data (i.e., the seconds since the last valid RTCM transmission); and
A differential reference station ID, from 0000 to 1023.

In addition to the Global Positioning System Fix Data, GPS module 140 and/or 156 can use the GPS data to generate and transmit the following interpreted sentences or “information” to the microprocessor 118 and/or 160a:
A waypoint arrival alarm;
GPS almanac data (which can also be received by the GPS unit);
Autopilot format “B”;
Bearing information—origin to destination;
Bearing and distance to waypoint—great circle;
Geographic position—latitude/longitude;
OPS range residuals;
GPS DOP and active satellites;
GPS pseudo range noise statistics;
GPS satellites in view;
Heading—true;
Control for a beacon receiver;
Beacon receiver status;
List of waypoints in currently active route;
Recommended minimum specific Loran-C data;
Recommended minimum navigation info;
Recommended minimum specific GPS/TRANSIT data;
Routes;
TRANSIT fix data;
Multiple data ID;
Dual ground/water speed;
Track made good and ground speed;
Waypoint location;
Cross-track error—measured; and
UTC date/time and Local Time Zone Offset.

The microprocessor 118 receives the foregoing information from the GPS module 140 and processes the information to forward at least a portion of the received information to the computer 160 of the CM 150. Additionally, the microprocessor 118 and/or the microprocessor 160a can be used to check a checksum of the received data to check for transmission errors.

The information received from the GPS module 140 and/or 156 can be graphically represented to a user on the display 162 of the computer 160 as part of a graphical user interface (“GUI”) readout that can include other parameters received from the SMs 110. Such a GUI can be designed to have the look of any application or can be customized per user requirements to adjust characteristics, such as, colors, logos, positions of controls, and control shapes, to name but only a few possible characteristics.

The computer 160 and/or the CM microprocessor 160a can be programmed with software to perform specific functions. In particular, there are several software packages that work together to provide the monitoring and control of the system 200, as described here below:

Command Station software can be provided to perform at least the following functions:
Fluid detection at each SM 110, for example; the rate of fluid rise and fall;
Present ambient temperature in degrees Fahrenheit and degrees Celsius at the SM 110;
System status warnings, provided in voice, text, graphical and digital formats to user devices 80 via a telephone, mobile, satellite, cellular and/or data network 90;
Status Message Center providing status for the present battery level, temperature, and general system condition, devices status, and voice status;
Voice status alerts;
Temperature alerts;
Fluid status;
Graphical fluid indicator;
Optional GPS at the main CM 150 with (latitude, longitude, altitude, speed, and heading);
Master power control for the device control system;
Master relay controller with an RF interface;
Sensory interface to the sensor system, automatic control of connected devices that also provide simultaneous feedback to the GUI showing the present status and conditions;
Over-ride for all connected systems/devices 130;
Voltage monitoring of all connected devices and controls to provide feedback that the actions requested have occurred;
Active internet connection and monitoring;
Active emailing system to send status and alarms to the user, via at least one of the user devices 80;
Cell phone, text and SMS messaging via at least one of the user devices 80; and
Cell phone control of the device under control, i.e. turn on, off and control of a defined pump 130 or device from one of the user devices 80.

Additionally, software or firmware can be provided that will configure the SM microcontroller 118 to perform a variety of functions, including:
Providing continuous monitoring of the devices and providing this data via signals that are sent to the main station software for processing and control;
Providing alarms and alerts that are sent in real time from the SM 110 to the main station software running on the CM 150 that provides monitoring and status controls for the system 200; and
Performing signal averaging to adjust for non-constant reading and generating false alarms or allowing the system to run without constant data against sensors 114, 116.

In some embodiments, CM 150 includes circuitry for communicating with a remote telephone and/or data network 90. The computer 160 of the CM 150 is configured to signal a transmitter that is preprogrammed to dial one or more telephone numbers when actuated. In one particular embodiment, such a transmitter is a BLUETOOTH transmitting device. The RF communications transceiver 156 can also be configured to communicate from the structure, vehicle, or vessel to a pre-programmed cellular telephone number of the boat owner's choice to alert of a condition with the vessel, vehicle, structure, or piece of equipment.

The system 200 provides many means to allow the control and monitoring of the present status of the device 130 and the surrounding area. This data is available to be sent via emails, SMS messages, MMS, internet page uploads, to mobile applications (i.e., cellular telephone, satellite phone, smartphone, etc.) for the monitoring and control of systems 130 and for controlling and/or monitoring the system 200 from remote locations.

More particularly, the system 200 includes a software algorithm for providing a web standard for bidirectional control from a device 80, 85 (i.e., a personal computer, cell phone, satellite phone, smartphone, PDA, etc.). The software algorithm is useful with an internet web server system that can be implemented. In particular, stream-oriented socket programs are provided that provide communication between a client and server of the system.

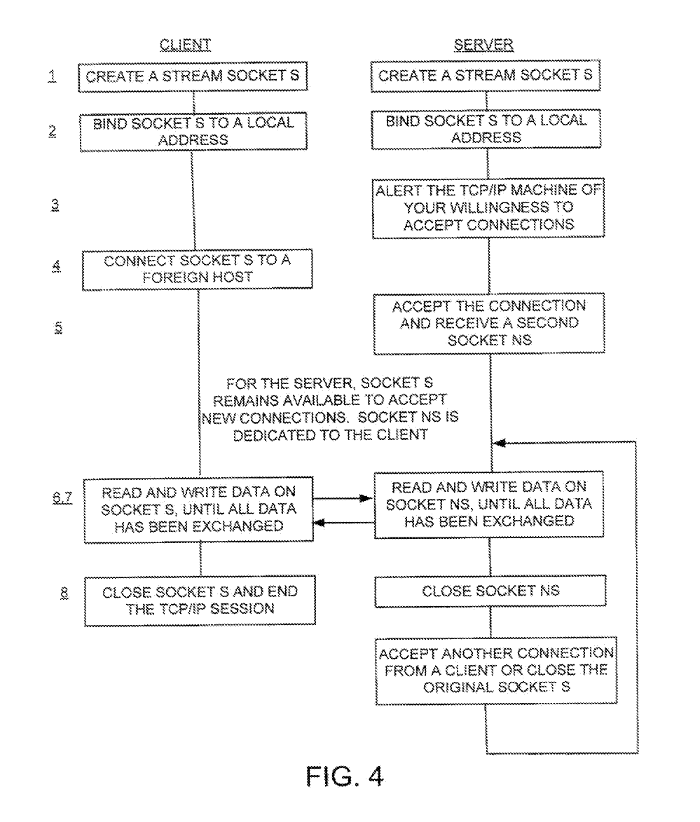

Referring now to FIG. 4, there is shown one particular flow diagram for the logic flow in a typical client/server system, which logic flow would be useful in connection with providing web-based access to information provided from the SM 110 of FIGS. 1 and 2. In some embodiments, the server starts before the client and waits for the client to request a connection (see, for example, Step 3). The server then continues to wait for additional client requests after the client connection has closed. The communications from a client to the system can be by voice activated instructions of any device in the system or controlling the functions of any device or the capabilities of the device or can provide voice notification.

The present invention can be embodied in the form of methods and apparatus for practicing those methods. The present invention can also be embodied in the form of program code embodied in tangible media, such as CD-ROMs, DVD-ROMs, Blu-ray disks, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

While the systems and methods have been described in its preferred form or embodiment with some degree of particularity, it is understood that this description has been given only by way of example and that numerous changes in the details of construction, fabrication, and use, including the combination and arrangement of parts, may be made without departing from the spirit and scope of the systems and methods. For example, although the systems and methods are described herein as a sensor system for monitoring devices, the present systems and methods are useful for monitoring a device and for actuating an event based on levels/inputs being monitored.

We claim:

1. A sensor system, comprising:
a sensor module disposed in a compartment, the sensor module including
first and second sensors, the second sensor separated from the first sensor in the compartment,
a first processor for monitoring the first and second sensors, and
a first transceiver for transmitting sensor data from the first processor to a location remote from said compartment.

2. The system of claim 1, wherein the transceiver is configured to communicate sensor data from the processor to a second transceiver remotely located from the compartment and that is in communication with a second processor.

3. The system of claim 2, wherein said second transceiver is configured to send a confirmation to the first receiver when sensor data is received at the second transceiver device.

4. The system of claim 3, wherein the sensor data received at the second transceiver device is processed by the second processor.

5. The system of claim 4, wherein the second processor is disposed in a main computer of one of a ship, a boat, a vehicle, a plane, and an office.

6. The system of claim 2, wherein the sensor module includes a GPS module for providing information related to location and/or time to at least one of the first processor and the second processor.

7. The system of claim 1, wherein the sensor module includes an accelerometer configured to provide an output to said processor.

8. The system of claim 2, wherein the sensor module is configured to control a pump.

9. The system of claim 8, wherein the sensor module is configured to actuates the pump in response to a command received from the second processor.

10. The system of claim 8, wherein the sensor module is configured to actuate the pump in response to a command received from a remote device.

11. The system of claim 10, wherein the remote device includes at least one of a handheld device, a mobile telephone, a cellular telephone, a smartphone, a satellite phone, a PDA, or a personal computer.

12. The system of claim 11, wherein the sensor module includes a camera module configured to acquire image data, the first processor configured to process the image data to provide processed image data and transmit the processed image data to the remote device.

13. The system of claim 1, wherein the sensor module is calibrated according to a calibration algorithm.

14. The system of claim 2, further comprising a plurality of sensor modules disposed in remote locations with respect to one another.

15. The system of claim 14, wherein the second processor is in signal communication with each of the plurality of sensor modules and is configured to control a plurality of systems in response to sensor data received from each of the plurality of sensor modules.

16. The system of claim 2, wherein the sensor module includes a plurality of sensors each configured to provide sensor data to the first processor.

17. The system of claim 16, wherein the first processor is configured to generate multi-length data packets for transmission by the to a location remote from said compartment.

18. The system of claim 1, wherein the first processor is configured to actuate a device coupled to the sensor module in response to an audible activation command.
